(19) United States
(12) Patent Application Publication
(10) Pub. No.: US 2004/0156689 A1
(43) Pub. Date: Aug. 12, 2004

(54) Drill bit

(76) Inventor: Shui Liang Shen, Zhejiang (CN)

Correspondence Address: BACON & THOMAS, PLLC, 625 SLATERS LANE, FOURTH FLOOR, ALEXANDRIA, VA, 22314

(21) Appl. No.: 10/365,739

(22) Filed: Feb. 7, 2003

(51) Int. Cl. B23B 51/02

(52) U.S. Cl. 408/212; 408/213; 408/225; 408/227

(57) ABSTRACT

The present invention to provide a high performance and versatile drill bit, for drilling curved bores, milling, countersinking and other application. A drill bit comprises a crown and a shank extending from the crown, wherein the crown comprises at least three cutting blades.

### BACKGROUND OF THE INVENTION

1. Field of the Invention

The present invention relates to a high performance and versatile drill bit, for drilling curved bores, milling, countersinking and other applications.

2. Description of the Related Art

Conventional drill bits, such as flat drill bits and twist drill bits, comprise cutting blades capable of cutting only in a forwards direction. These drills lack versatility, being able to only cut straight holes. Separate tools, for example milling tools or countersinking bits, are needed if it is required to cut grooves, recesses or the like. In many situations it is desirable to drill a curved hole, for example to allow insertion of a flexible tubing without subjecting it to detrimental bending. Conventional drill bits are only capable of producing bores to round corners that includes sharp angles.

In addition to their limited scope of use, the cutting performance of known drill bits is generally limited, with drill bits often having a poor cutting speed and smoothness of cutting. Limitations arise due to factors such as a requirement for the application of heavy pressure or frequent clogging of the drill bit with saw dust. A versatile drill bit would provide the great advantage of enabling diverse applications, for example the cutting of recesses for installing locks and drilling of curved bores for installing cables or tubing, to be carried with greater ease and without the requirement for the use of multiple tools.

Drill bits are known that have the ability to cut in three directions. The known “3D bit” described in European Patent 0181841 is a drill bit for cutting wood and other soft materials. It comprises a crown having two forward (axial) cutting edges, two side (radial) cutting edges and two rear (axial) cutting edges. This arrangement of cutting edge enables the cutting of grooves, recesses and curved bores, in addition to straight bores.

### SUMMARY OF THE INVENTION

The present invention provides a new highly versatile drill bit with a cutting blade geometry that provides a remarkably improved cutting performance over all known drill bits.

In a first aspect the present invention provides a drill bit comprising a crown and a shank extending from the crown, wherein the crown comprises at least three cutting blades.

Preferably an embodiment of a drill bit according to the present invention provides a drill bit wherein the crown comprises an odd number of cutting blades.

Preferably an embodiment of a drill bit according to the present invention provides a drill bit wherein the crown comprises three cutting blades. More preferably the three cutting blades are disposed from the longitudinal axis of the drill bit at an angle of 120° with respect to each other. Even more preferably each three cutting blade is identical.

Preferably an embodiment of a drill bit according to the present invention provides a drill bit wherein each cutting blade comprises a first axially cutting face, a radially cutting face and a second axially cutting face. More preferably each cutting face comprises at least one cutting edge.

Preferably an embodiment of a drill bit according to the present invention includes a first axially cutting face having a first axially cutting edge that bisects a radius of the crown. More preferably the first axially cutting edge trails the radius of the crown, relative to the intended direction of rotation for cutting. In contrast preferably the trailing edge of the first axially cutting face lies on a radius of the crown.

Preferably an embodiment of a drill bit according to the present invention comprises a cutting blade having a wing. Preferably, the wing is wedge shaped. More preferably thee wing extends circumferentially from the end of each blade distal to the central longitudinal axis of the crown. More preferably the wing has a curved outer face. Even more preferably, each wing extends circumferentially from the face of a blade adjacent the first axially cutting edge and the projecting edge of each wing forms a radially cutting edge.

Preferably each cutting blade is provided with a wedge shaped tooth that projects from the blade in an axial direction to a greater extent than the first axially cutting face. More preferably the tooth tapers to from a third axially cutting edge. Even more preferably the third axially cutting edge is provided proximal to the first axially cutting edge. Furthermore, the third axially cutting edge is curved from a first end where it meet the radially cutting edge to a straight portion at its opposing end on top of the crown.

Preferably an embodiment of a drill bit according to a first aspect of the present invention has a crown that comprises an axial tapered cutting tip positioned on the longitudinal axis of the drill bit wherein the cutting tip projects in an axial direction further from the shank than any other part of the crown. More preferably the cutting tip is tapered an angle of about 20° to about 40°. Even more preferably the cutting tip tapers at an angle of about 25° to about 35°. Even more preferably the cutting tip tapers at an angle of about 30°.

Preferably the tapered cutting tip is pyramidal and has three sides which are tapered at the angles described above.

Preferably an embodiment of a first aspect of the present invention comprises an attachment portion for a drilling machine positioned adjacent the shank distal to the crown. More preferably the attachment portion is of wider diameter than the shank. Even more preferably there is a collar between the shank and the attachment portion, increasing in diameter from that of the shank to that of the attachment portion. Even more preferably the collar has a rough texture for providing grip.

A preferred embodiment of a drill bit according to the present invention provides a drill bit comprising a titanium nitrate (TiNO₃) coating.

Preferably an embodiment of a drill bit according to the present invention provides a drill bit comprising 1060 high carbon steel and is of the hardness HRC 45-55.

An advantage of the present invention is that it provides a drill bit comprising at least three cutting blades, rather than the known arrangement of two cutting blades, thereby increasing the speed of cutting and smoothness of cut.

A further advantage is that the cutting blades are more stable while cutting, thereby reducing the chatter or vibration of the drill bit when in use. The chatter of a drill bit according to this invention is reduced relative to know drill bits when cutting in any one of the possible cutting directions. The reduction of chatter is most substantial when the drill bit is used for milling in a radial direction.

A further advantage of the present invention is that it provides a drill bit that has a smoother radial ccutting action than known drill bits. The cut produced is cleaner and more accurate than that produced by any know drill bit.

A drill bit according to this invention has a particular advantage when being used to cut a channel in a surface. A reaction force, or angular frication, is generated by each radial cutting edge or wing. The direction of this force has a stabilizing effect and reduces any tendency of the drill bit to jump out of a channel whilst cutting. This advantage arises due to the particular geometry of the cutting blades in relation to the central axis of the shaft and the direction of rotation. In contrast to the invention, the cutting blades of known drill bits are positioned so that they precede the radius, rather than trail it, In these circumstances, the reaction force generated is directed out of the channel and a tendency of a drill bit to jump out of the channel is increased.

A further advantage of the present invention is that it provides a drill bit with improved cutting of wood, ejection of wood chips and thereby improved cutting speed. The gap between the cutting blades of the present invention has a larger volume than in known drill bits. Consequently the drill bit of the invention is less likely to clog with excess wood chips.

An advantage of the present invention is that it provides a drill bit comprising a cutting tip that is designed to prevent slipping. The tapered cutting tip of the present invention preferably has three sides and comes to a sharp point. It is less likely to slip than the known four-sided cutting tips of known drill bits, wherein the tip tapers to a less sharp point.

An advantage of the present invention is that it provides a drill bit comprising a TiNO₃ coating, providing an increase in the hardness of the drill surface. A TiNO₃ coating thus provides a drill bit with a greater resistance to wear and therefore extends the working life of the drill bit.

A further advantage of a TiNO₃ coating is a reduction of friction, thereby favourably reducing the operating temperature of the drill. Additional advantages of a TiNO₃ coating are that it serves to inhibit corrosion and provides an attractive shiny finish to the drill bit.

The improved drilling performance of a drill bit according to this invention allows a drill bit be manufactured from a reduced hardness of steel whilst achieving the same cutting speeds as with know drill bits. Conversely, a drill bit according to this invention, comprising high performance steel gives a significant increase in performance over know drill bits of this type, enabling of harder materials than was previously possible.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 show a side view of a preferred embodiment of a drill bit according to the present invention.

FIG. 2 shows an end view of three cutting blades of a crown of a preferred embodiment of a drill bit according to the invention.

FIG. 3 shows a view along the longitudinal axis of a preferred embodiment of the present invention whilst cutting a groove. The direction of rotation, frictional force and reaction force pointing into a channel are shown.

FIG. 4 shows a view along the longitudinal axis of a drill bit where the blades precede the radius rather than trail it. The direction of rotation, frictional force and reaction force pointing out of a channel are shown.

### DETAILED DESCRIPTION OF THE PREFERRED EMBODIMENTS

For the purposes of clarity and a concise description features are described herein as part of the same or separate embodiments, however it will be appreciated that the scope of the invention may include embodiment having combinations of all or some of the features described.

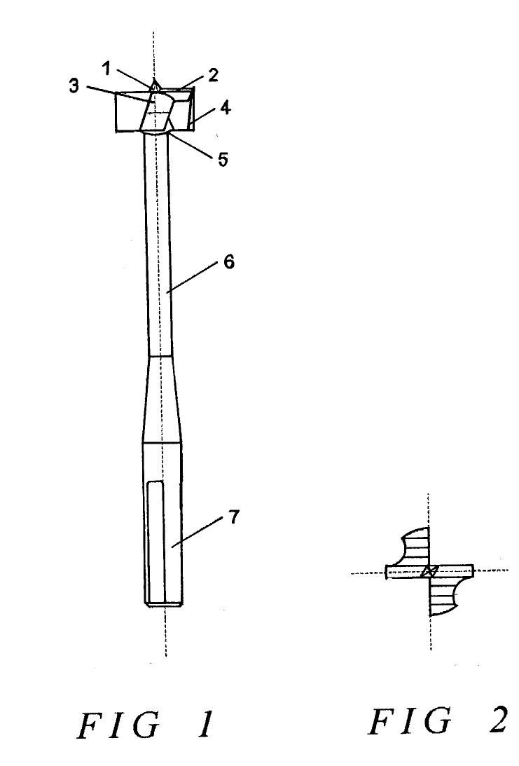

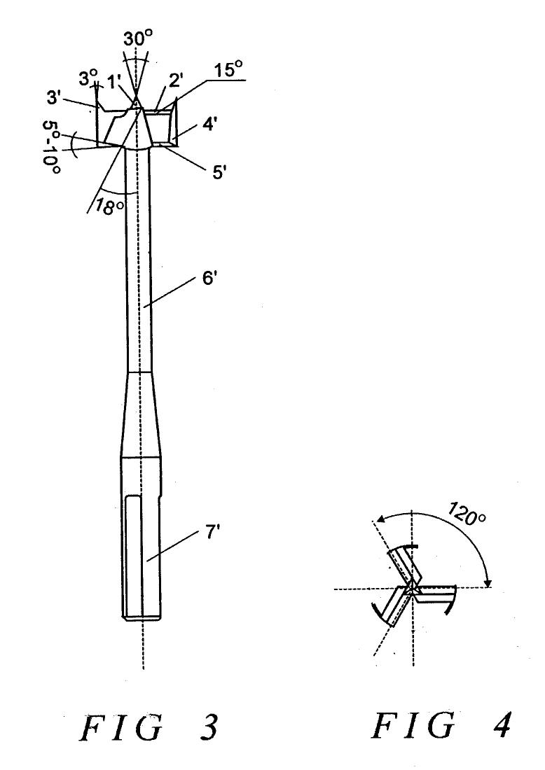

A preferred embodiment of a drill bit according to the invention is shown in FIGS. 1 and 2. The drill bit comprises a crown (6); a shank(7) which extends from the crown(6); a collar(9) adjacent the shank(7) distal to the crown(6); and an attachment portion(8) adjacent the collar(9) and distal to the crown(6). The drill bit has a TiNO₃ coating.

The shank (7) is coaxial with the crown(6) and is of significantly smaller diameter than the crown(6).

The crown (6) comprises a cutting tip(1) on its central longitudinal axis. The cutting tip(l) comprises a pyramid having a base and three sides each tapered to a 30° point. In addition, the crown (6) comprises three identical cutting blades which extend radially from the central longitudinal axis of the crown. The cutting blades are separated from each other by an angle of 120°.

Each cutting blade comprises a first axially cutting face having a first axially cutting edge (2); and a second axially cutting face having a second axially cutting edge (5). The first and second axially cutting faces oppose each other and the first and second cutting edges are for cutting in opposite directions. The first axially cutting face bisects a radial plane of the crown at an angle of about 15°. The second axially cutting face bisects a radial plane of the crown at an angle of about 5° to 10°. In addition, the second axially cutting face bisects an axial plane of the crown at an angle of about 5° to about 10°.

In addition, each cutting blade comprises a wedge shaped wing that extends circumferentially from the end of each blade distal to the central longitudinal axis of the crown. Each wing extends circumferentially from the face of a blade adjacent the first axially cutting edge. The projecting edge of each wing forms a radially cutting edge (4). The radial cutting edge (4) bisects an axial plane of the crown (6) at an angle of 18°.

The radially outer face of the wing bisects a circumferential plane at an angle of 3° so that the wing is radially more distant from the central longitudinal axis of the crown adjacent the first axially cutting face than adjacent the second axially cutting face.

In addition, each cutting blade comprises a wedge shaped tooth located atop the join between a wing and a first axially cutting face. Each tooth has a third axially cutting face having a third axially cutting edge (3). The third axially cutting edge (3) is provided adjacent the first axially cutting edge (2). Furthermore, the third axially cutting edge is curved from a first end where it meets the radially cutting edge to a straight portion at its opposing end.

It should be understood that various changes and modification to the presently preferred embodiments described herein will be apparent to those skilled in the art. Such changes and modification can be made without departing from the spirit and scope of the present invention and without diminishing its attendant advantages. It is therefore intended that such changes and modifications are covered by the appended claims.

What is claimed is:

1. A drill bit comprising a crown and a shank extending from the crown, wherein the crown comprises at least three cutting blades.

2. A drill bit according to claim 1 having an odd number of cutting blades.

3. A drill bit according to claim 2 wherein the crown comprises three cutting blades.

4. A drill bit according to claim 3 wherein the three cutting blades are disposed from the longitudinal axis of the drill bit at an angle of 120 with respect to each other.

5. A drill bit according to claim 1 wherein each cutting blade is identical.

6. A drill bit according to claim 1 wherein each cutting blade comprises a first axially cutting face, a radially cutting face and a second axially cutting face.

7. A drill bit according to claim 6 wherein each cutting face comprises at least one cutting edge.

8. A drill bit according to claim 7 comprising a first axially cutting face having a first axially cutting edge that bisects a radius of the crown.

9. A drill bit according to claim 8 wherein the first axially cutting edge trails the radius of the crown, relative to the intended direction of rotation for cutting.

10. A drill bit according to claim 8 wherein the trailing edge of the first axially cutting face lies on a radius of the crown.

11. A drill bit according to claim 1 comprising a cutting blade having a wing.

12. A drill bit according to claim 11 wherein the wing is wedge shaped.

13. A drill bit according to claim 11 wherein the wing extends circumferentially from the end of each blade distal to the central longitudinal axis of the crown.

14. A drill bit according to any one of claims 11 wherein the wing has a curved outer face.

15. A drill bit according any one of the claims 11 wherein each wing extends circumferentially from the face of a blade adjacent the first axially cutting edge and the projecting edge of each wing forms radially cutting edge.

16. A drill bit according to claim 1 wherein each cutting blade is provided with a wedge shaped tooth that projects form the blade in an axial direction to a greater extent than the first axially cutting face.

17. A drill bit according to claim 16 wherein the tooth tapers to form a third axially cutting edge.

18. A drill bit according to claim 17 wherein the third axially cutting edge is provided proximal to the first axially cutting edge.

19. A drill bit according to claim 18 wherein the third axially cutting edge is curved from a first end where it meets the radially cutting edge to a straight portion at its opposing end on top of the crown.

20. A drill bit according claim 1 wherein the crown comprises an axial tapered cutting tip position on the longitudinal axis of the drill bit wherein the cutting tip projects in an axial direction further from the shank than any other part of the crown.

21. A drill bit according to claim 20 wherein the cutting tip is tapered at an angle of about 20 to about 40

22. A drill bit according to claim 20 wherein the tapered cutting tip is pyramidal and has three sides, each tapered at an angle of about 20 to about 40

23. A drill bit according to claim 1 comprising an attachment portion for a drilling machine positioned adjacent the shank distal to the crown.

24. A drill bit according to claim 23 wherein the attachment portion is of a wider diameter than the shank.

25. A drill bit according to claim 24 comprising a collar between the shank and the attachment portion, increasing in diameter from that shank to that of the attachment portion.

26. A drill bit according to claim 25 wherein the collar has a rough texture for providing grip.

27. A drill bit according claim 1 comprising a titanium nitrate (TiNO₃) coating.

28. A drill bit according to claim 1 that comprises 1060 high carbon steel and is of the hardness HRC 45-55.

29. A drill bit substantially as described herein with reference to or as illustrated in any of the figures of the accompanying drawings.
